(19) United States
(12) Patent Application Publication
(10) Pub. No.: US 2025/0010259 A1
(43) Pub. Date: Jan. 9, 2025

(54) BLUE HYDROGEN PROCESS AND PLANT

(71) Applicant: Topsoe A/S, Kgs. Lyngby (DK)

(72) Inventors: Nitesh BANSAL, Noida (IN); Aditya SINGH, Frankfurt am Main (DE); Yassir I. Z. GHIYATI, Frederiksberg C (DK)

(73) Assignee: Topsoe A/S, Kgs. Lyngby (DK)

(21) Appl. No.: 18/705,659

(22) PCT Filed: Nov. 14, 2022
(86) PCT No.: PCT/EP2022/081812

§ 371 Date: Apr. 29, 2024

(30) Foreign Application Priority Data
Nov. 15, 2021 (IN) 202111052313
Jan. 21, 2022 (IN) 202211003488
Mar. 11, 2022 (DK) PA 2022 00199

(51) Int. Cl. B01J 8/04; B01D 53/047; C01B 3/48; C01B 3/50; C01B 3/56

(52) U.S. Cl. CPC B01J 8/0492; B01D 53/047; B01J 8/0496; C01B 3/48; C01B 3/501; C01B 3/506; C01B 3/56; B01D 2256/16; B01D 2257/504; B01J 2208/00504; C01B 2203/0244; C01B 2203/0283; C01B 2203/0405; C01B 2203/042; C01B 2203/046; C01B 2203/0475; C01B 2203/0811; C01B 2203/1241; C01B 2203/142

(57) ABSTRACT

A plant and process for producing a hydrogen rich gas are provided, said process comprising the steps of: steam reforming a hydrocarbon feed into a synthesis gas; shifting the synthesis gas and conducting the shifted gas to a hydrogen purification unit, subjecting CO₂-rich off-gas from the hydrogen purification unit to a carbon dioxide removal and recycling CO₂-depleted off-gas rich in hydrogen to the process.

### FIELD OF THE INVENTION

The present invention relates to a plant and process for the production of hydrogen from a hydrocarbon feed, and comprising: reforming, shift conversion, CO₂-removal and hydrogen purification. In particular, the present invention concerns a plant and process for producing hydrogen from a hydrocarbon feed, in which the hydrocarbon feed is subjected to reforming in reforming unit for generating a synthesis gas, subjecting the synthesis gas to shift conversion step, and then treating the shifted gas in a hydrogen purification unit, such as a pressure swing adsorption (PSA) unit, whereby a hydrogen product is withdrawn as well as a CO₂-rich off-gas stream, and where the CO₂-rich off-gas stream is subjected to CO₂-removal thereby generating a CO₂-depleted stream, i.e. a CO₂-depleted off-gas stream, which is fed to the reforming unit; for instance, the CO₂-depleted stream or a portion thereof is added as feed and/or fuel to the reforming unit, or as fuel in a fired heater. The CO₂-de-pleted stream or a portion thereof may also be added to the shift conversion step and/or to the hydrogen purification unit. The CO₂-depleted stream or a portion thereof may also be exported e.g. outside the hydrogen purification unit, more specifically, outside the plant.

### BACKGROUND

Following today's demand and competitiveness in hydrogen production, significant efforts have been put into developing optimized production for hydrogen plants, with the objective to improve overall energy efficiency and reduce capital cost. The need for more cost-efficient hydrogen production has spurred the development of technology and catalysts for large-scale hydrogen production units, in order to benefit from economy of scale.

Topsøe's latest innovations within hydrogen production technology and the development of a new generation of state-of-the-art catalysts ensure highly cost-efficient hydrogen production and high plant reliability also for large single line capacities.

Applicant's WO 2020221642 A1 discloses a plant and process for producing hydrogen, which comprises autothermal reforming (ATR) for generating a syngas (synthesis gas), water gas shift, CO₂-removal of the shifted gas, and hydrogen purification to generate a hydrogen-rich gas and an off-gas stream. The off-gas stream is recycled to e.g. the ATR, and prior to this the off-gas may be subjected to a compression and membrane separation step. When for instance using a CO₂ membrane separation unit in the off-gas stream, the permeate is a stream richer in hydrogen which is then passed to hydrogen purification unit, e.g. PSA unit, while the retentate is a hydrogen-lean stream which is recycled to the feed side of the ATR, or feed side of shift section.

It would be desirable to improve this process for producing hydrogen.

WO 2016187125 A1 discloses a process for incremental hydrogen production of an existing plant for producing hydrogen from natural gas. The existing plant comprises steam reforming, water gas shift and hydrogen purification in a pressure swing adsorption (PSA) unit, thereby producing a first H₂-stream and a PSA off-gas stream. The PSA off-gas (first waste stream) is compressed, dried and CO₂ is removed from the stream in a low temperature CO₂ separation unit. A remaining waste stream is produced and sent to a second PSA unit, from which a second H₂-stream is withdrawn, as well as a second PSA off-gas stream (second waste stream) which is passed to the steam reforming furnace as fuel gas.

US 2013156685 discloses a process for reducing the total CO₂-production of a hydrogen producing plant, including CO₂-recovery from the flue gas of a reformer furnace (steam methane reformer, SMR). Three pre-reforming steps are conducted for producing the hydrocarbon feed to the reformer furnace. A residual stream from a PSA unit downstream the reformer furnace is sent to a CO₂-separation unit, from which a H₂-rich stream, a CO₂-stream, and a residual stream are produced. The residual stream is then recycled to upstream the reformer furnace, or as fuel in the reformer furnace. This citation is at least silent on: the provision of reforming furnace configurations other than conventional SMR or ATR, the provision of a single pre-reformer (single stage pre-reforming), and the provision of at least a fired heater arranged to pre-heat the hydrocarbon feed prior to being fed to the reforming furnace.

It would be desirable to also improve these processes and plants for producing hydrogen.

### SUMMARY

It is therefore an object of the present invention to reduce consumption of hydrocarbon feed and fuel in a hydrogen plant and/or process, thereby increasing energy efficiency, while at the same time increasing carbon dioxide capture and hence reducing CO₂ emissions.

It is another object of the present invention to provide a better integration of the CO₂ removal in a hydrogen plant and/or process.

These and other objects are solved by the present invention.

Accordingly, in a first aspect, there is provided a plant (100) for producing a H₂-rich stream (8) from a hydrocarbon feed (1), said plant comprising:
a reforming unit (110), said reforming unit (110) being arranged to receive a hydrocarbon feed (1, 2) and convert it to a stream of syngas (3);
a shift section (115, 150), said shift section (115, 150), suitably comprising a high or medium temperature shift unit (115), said shift section being arranged to receive a stream of syngas (3) from the steam reforming unit (110) and shift it, suitably in a high or medium temperature shift step, thereby providing a shifted syngas stream (5);
a hydrogen purification unit (125), arranged to receive said shifted syngas stream (5) and separate it into a high-purity H₂ stream as said hydrogen product (8), and CO₂-rich off-gas stream (9);
a CO₂-removal section (180) for removal of CO₂ from the CO₂-rich off-gas stream (9) into a CO₂-product stream (11) and a CO₂-depleted off-gas stream (17, 17′, 17″), and wherein said plant is arranged for recycling said CO₂-depleted off-gas stream (17, 17′, 17′') or a portion thereof, at least to the feed side of the reforming unit (110);

the plant further comprising:
at least one fired heater arranged to pre-heat said hydrocarbon feed (1, 2) prior to it being fed to the reforming unit (110) e.g. ATR, and wherein said plant (100) is arranged to feed at least a part of the CO₂-rich off-gas stream (9) from said hydrogen purification unit (125), or at least part of said CO₂-depleted off-gas stream (17, 17′, 17″) as fuel for said fired heater.

Also provided, in a second aspect of the invention, as recited farther below, is a process for producing a H₂-rich stream from a hydrocarbon feed, using the plant as defined herein.

Further details of the invention are set out in the following description, following figure, aspects and the dependent claims.

As used herein, the term “first aspect of the invention” means the plant (system) according to the invention; the term “second aspect of the invention” means the process according to the invention.

As used herein, the term “comprising” encompasses also “comprising only” i.e. “consisting of”.

As used herein, the term “suitably” means “optionally”, i.e. an optional embodiment.

As used herein, the term “at least a part” means at least a portion, e.g. at least a portion of a given stream. Accordingly, the term “at least a part” or “at least a portion” of a given stream means the entire stream or a portion thereof.

As used herein, the term “present invention” or simply “invention” may be used interchangeably with the term “present application” or simply “application”.

Other definitions are provided in connection with one or more of below embodiments.

In a particular embodiment, the plant is arranged to directly recycle said CO₂-depleted off-gas stream or a portion thereof, at least to the feed side of the reforming unit. In another particular embodiment, the plant is arranged to directly feed: at least a part of the CO₂-rich off-gas stream from said hydrogen purification unit, or at least part of said CO₂-depleted off-gas stream as fuel for said fired heater.

As used herein, the term “directly” means that there are no intermediate steps or units changing the composition of the stream. For instance, as depicted in the appended figure, the plant 100 is arranged to directly recycle said CO₂-depleted off-gas stream 17, 17′, 17″ or a portion thereof, at least to the feed side of the reforming unit 110.

In an embodiment, the reforming unit is an autothermal reformer (ATR); a partial oxidation reformer (POₓ); a convection heated reformer such as a heat exchanger reformer (HER) or gas heated reformer (GHR); a steam methane reformer (SMR), such as an electrically heated steam methane reformer (e-SMR); or combinations thereof, such as a SMR in combination with (HER), or SMR in combination with ATR, or ATR in combination with HER.

All the above recited reforming units are well known in the art.

For instance:
in an autothermal reformer (ATR), there is partial oxidation of the hydrocarbon feed with oxygen and steam followed by catalytic reforming; in autothermal reforming (ATR), herein also encompassing the term catalytic partial oxidation (CPO), natural gas or other hydrocarbons are reacted with steam and an oxidant (air, enriched air, or oxygen) in the presence of a catalyst based on nickel or noble metals;
in non-catalytic partial oxidation (POₓ) of natural gas, light hydrocarbons, heavy hydrocarbons or solid feedstock such as coal (also referred to as gasification) is reacted with an oxidant (air, enriched air or oxygen) and outlet temperatures from the reactor of up to 1400° C. are obtained;
a convection reformer, may comprise one or more bayonet reforming tubes such as an HTCR reformer i.e. Topsøe bayonet reformer, where the heat for reforming is transferred by convection along with radiation;
the term SMR encompasses conventional SMR and e-SMR; in a conventional SMR, also referred to as tubular reformer, the heat for reforming is transferred chiefly by radiation in a radiant furnace; in electrically heated steam methane reformer (e-SMR), electrical resistance is used for generating the heat for catalytic reforming. In particular, when using e-SMR, electricity from green resources may be utilized, such as from electricity produced by wind power, hydropower, and solar sources, thereby further minimizing the carbon dioxide footprint.

For more information on these reformers, details are herein provided by direct reference to Applicant's patents and/or literature. For instance, for tubular and autothermal reform- ing an overview is presented in “Tubular reforming and autothermal reforming of natural gas-an overview of available processes”, Ib Dybkjær, Fuel Processing Technology 42(1995) 85-107, EP 0535505 for a description of HTCR, or e.g. EP 2526045 for a description of a HER, or e.g. EP 0983963 for a description of process combining ATR and HER. For a description of ATR and/or SMR (tubular reformer) for large scale hydrogen production, see e.g. the article “Large-scale Hydrogen Production”, Jens R. Rostrup-Nielsen and Thomas Rostrup-Nielsen ”, CATTECH, volume 6, pages 150-159 (2002). For a description of e-SMR which is a more recent technology, reference is given to e.g. WO 2019/228797 A1.

In an embodiment, the catalyst in the reforming unit is a reforming catalyst, e.g. a nickel based catalyst. In an embodiment, the catalyst in the water gas shift reaction (i.e. in the shift section) is any catalyst active for water gas shift reactions. The said two catalysts can be identical or different. Examples of reforming catalysts are Ni/MgAl₂O₄, Ni/Al₂O₃, Ni/CaAl₂O₄, Ru/MgAl₂O₄, Rh/MgAl₂O₄, Ir/MgAl₂O₄, MO₂C, Wo₂C, CeO₂, Ni/ZrO₂, Ni/MgAl₂O₃, Ni/CaAl₂O₃, Ru/MgAl₂O₃, or Rh/MgAl₂O₃, a noble metal on an Al₂O₃ carrier, but other catalysts suitable for reforming are also conceivable. The catalytically active material may be Ni, Ru, Rh, Ir, or a combination thereof, while the ceramic coating may be Al₂O₃, ZrO₂, MgAl₂O₃, CaAl₂O₃, or a combination therefore and potentially mixed with oxides of Y, Ti, La, or Ce. The maximum temperature of the reactor may be between 850-1300° C. The pressure of the feed gas may be 15-180 bar, preferably about 25 bar. Steam reforming catalyst is also denoted steam methane reforming catalyst or methane reforming catalyst.

In a particular embodiment, the reforming unit is an autothermal reformer (ATR). The ATR enables operating the plant and process at low steam/carbon ratio thereby i.a. reducing equipment size. For instance, the steam/carbon ratio of the synthesis gas supplied from the ATR to the shift section is less than 2.0 preferably 0.3-1.0.

As used herein, the term “feed side” means inlet side or simply inlet. For instance, the feed side of the reforming unit, e.g. ATR, means the inlet side of the ATR.

As used herein, the term CO₂-product stream means a stream containing 95% vol. or more, for instance 99.5% of carbon dioxide.

The CO₂-depleted off-gas stream means a stream comprising for instance: 85 mol % H₂, 7 mol % CH₄, 7 mol % CO and 1 mol % N₂+Ar. Hence, the CO₂-depleted off-gas stream is hydrogen-rich, i.e. having more than 80 mol % H₂, and essentially free of carbon dioxide.

In an embodiment, the plant (100) is absent of a CO₂-removal section upstream said hydrogen purification unit (125), arranged to receive the shifted gas stream (5) from said shift section. Accordingly, the plant is arranged to directly provide, i.e. to directly feed, said shifted syngas stream (5) to said hydrogen purification unit (125),

It has been found, that it is advantageous to recycle, thus to feed CO₂-depleted off-gas having a high hydrogen content back to steam reforming unit, while at the same time avoiding the use of a CO₂-removal in between the shift section and hydrogen purification unit. This results in more reforming of methane into hydrogen as well as shifting of CO into CO₂. The benefits of this plant and process include also reduction of hydrocarbon feed consumption, e.g. natural gas consumption, for the same required hydrogen production while increasing the CO₂-capture and hence reducing the CO₂ emission.

Furthermore, the CO₂-removal is conducted in a much smaller process gas stream (the CO₂-rich off-gas stream) than the shifted syngas stream.

The CO₂ product stream from the CO₂ removal step may be subjected to storage or used for other purposes to reduce the CO₂ emission to atmosphere.

Improvement of the process is thereby obtained, not least by a better integration of the CO₂ removal process, thus providing a superior blue-hydrogen process whereby carbon dioxide is removed while generating the hydrogen product.

The term “blue-hydrogen” means that hydrogen is produced from a hydrocarbon feed such as natural gas, while supported by carbon capture and its storage or utilization.

In an embodiment, the CO₂ removal section (180) is selected from: an amine wash unit, or a CO₂ membrane i.e. CO₂ membrane separation unit, CO₂-PSA, or a cryogenic separation unit.

In particular, when using a CO₂ membrane separation unit, the permeate is the stream richer in hydrogen which may then be passed to a hydrogen purification unit, e.g. PSA unit, while the retentate is a hydrogen-lean stream which is recycled to the feed side of the ATR, or feed side of shift section, or the feed side i.e. inlet side of the membrane separation.

The CO₂ removal section can also be a Benfield process or plant comprising an absorber for conducting a gas absorbing step and a regenerator for conducting a carbonate regeneration step. The CO₂ removal section can also be in the form of a CO₂-PSA, as is also well known in the art.

In an embodiment, the plant (100) further comprises one prereformer unit (140) arranged upstream the reforming unit (110), said prereformer unit (140) being arranged to pre-reform said hydrocarbon feed (1) prior to it being fed to the steam reforming unit (110) and wherein said plant (100) is arranged to feed at least a part of the CO₂-depleted off-gas stream (17, 17′) to the feed side of the prereformer unit (140); and/or
said plant (100) is arranged to feed at least a part of the CO₂-depleted off-gas stream (17) to the feed side of the shift section; and/or
said plant is arranged to feed at least a part of said CO₂-depleted off-gas stream to the feed side of the hydrogen purification unit (125).

As used herein, the terms prereformer, prereformer unit and prereforming unit, are used interchangeably.

In an embodiment, the pre-reformer unit is an adiabatic prereformer unit.

By providing a single pre-reformer unit, such as an adiabatic prereformer unit, a simpler plant and process are provided. Associated capital expenditure (CapEx) and operating expenses (OpEx) for provision of additional pre-reformers and attendant heat exchanging units, are eliminated.

As used herein, the feed side of the shift section means the inlet side of the high or medium temperature shift unit, or the inlet side of any downstream shift unit downstream in said shift section, such as a medium temperature shift unit arranged downstream a high temperature shift unit.

Recycling of the CO₂-depleted off-gas stream to e.g. the ATR has the advantage of reducing the flow to the prereformer, and thereby reducing its size. More specifically, the recycling of CO₂-depleted off-gas increases the hydrogen recovery and thereby the feed consumption is reduced. Due to this, the upstream equipment may reduce in size.

Recycling of CO₂-depleted off-gas stream to the shift section has the advantage of reducing the size of both ATR and prereformer. This recycle option is preferably combined with a second H₂ purification step on the off-gas, suitably upstream the CO₂-removal section, to reduce H₂ partial pressure.

In an embodiment, the plant is without i.e. is absent of a steam methane reformer unit (SMR) upstream the ATR. Hence, the reforming section, i.e. the reforming unit therein, comprises an ATR and optionally also a pre-reforming unit, yet there is no steam methane reforming (SMR) unit, i.e. the use of e.g. a conventional SMR (also normally referred as radiant furnace, or tubular reformer) is omitted. Accordingly, in an embodiment, the reforming unit is an ATR with said one prereformer unit arranged upstream. The ATR together with a pre-reforming unit, i.e. stand-alone ATR, is a simple and energy efficient solution for the reforming section.

This conveys significant advantages in terms of energy consumption and plant size since it is now possible, among other things, to operate at steam to carbon molar ratios well below 1 and thereby significantly reducing the amount of steam carried in the plant/process, as also recited farther above.

Suitably, the plant further comprises a hydrogenator unit and a sulfur absorption unit arranged upstream said pre-reformer unit, wherein said plant is arranged to feed at least a part of the CO₂-depleted off-gas stream to the feed side of the hydrogenator unit.

In an embodiment, the plant further comprises:
a compressor i.e. CO₂-rich off-gas recycle compressor arranged for compressing said CO₂-rich off-gas stream (9), said compressor being adapted upstream said CO₂ removal section (180), and optionally a compressor being adapted downstream said CO₂ removal section (180), for recycling said CO₂-depleted-gas stream (17, 17′, 17″) to the feed side of the reforming unit (140), and/or to the feed side of the shift section, and/or to the feed side of the prereformer unit (140), and/or to the feed side of the hydrogen purification unit (125).

The invention enables also reducing the power consumption of the CO₂-rich off-gas recycle compressor, by adding the CO₂-depleted off-gas back to reforming section, e.g. to the prereformer and/or ATR.

At least a part of the compressed part of the CO₂-depleted off-gas stream is used in the process by directly becoming a part of the hydrocarbon feed or process gas being treated in e.g. the prereformer, or ATR, or shift section.

Suitably, the high temperature shift unit comprises a promoted zinc-aluminium oxide based high temperature shift catalyst, preferably arranged within said HTS unit in the form of one or more catalyst beds, and preferably wherein the promoted zinc-aluminum oxide based HT shift catalyst comprises in its active form a Zn/Al molar ratio in the range 0.5 to 1.0 and a content of alkali metal in the range 0.4 to 8.0 wt % and a copper content in the range 0-10% based on the weight of oxidized catalyst.

In a conventional hydrogen plant the standard use of iron based high temperature shift catalyst re-quires a steam/carbon ratio of around 3.0 to avoid iron carbide formation.

5Fe₃O₄+32CO⇄3Fe₅C₂+26 CO₂ (1)

Formation of iron carbide will weaken the catalyst pellets and may result in catalyst disintegration and pressure drop increase.

Iron carbide will catalyse Fischer-Tropsch by-product formation

nCO+(n+m/2)H₂⇄CₙHₘ +nH₂O (2)

The Fischer-Tropsch reactions consume hydrogen, whereby the efficiency of the shift section is reduced.

However, according to the present invention a non Fe-catalyst is used, such as a promoted zinc-aluminum oxide based catalyst. For example, the Topsøe SK-501 Flex™ HT shift catalyst which enables operation of the reforming section and high temperature shift section at a steam/carbon ratio down to 0.3.

Thus, the present plant and/or process operating at a steam/carbon ratio down to 0.3 is in contrast to today's traditional hydrogen plants which are based on reforming and/or shift sections operating at a steam/carbon ratio of around 1.5 or higher. In advantageous embodiments of the process the zinc-aluminum oxide based catalyst in its active form comprises a mixture of zinc aluminum spinel and zinc oxide in combination with an alkali metal selected from the group consisting of Na, K, Rb, Cs and mixtures thereof, and optionally in combination with Cu. The catalyst, as recited above, may have a Zn/Al molar ratio in the range 0.5 to 1.0, a content of alkali metal in the range 0.4 to 8.0 wt % and a copper content in the range 0-10% based on the weight of oxidized catalyst.

The high temperature shift catalyst used according to the present process is not limited by strict requirements to steam to carbon ratios, which makes it possible to reduce steam/carbon ratio in the shift section as well as in the reforming section.

Again, significant reduction in the amount of steam carried in the plant and/or process is obtained, thereby reducing plant size and energy consumption. More specifically, a steam/carbon ratio of less than 2.0 has several advantages. Reducing steam/carbon ratio on a general basis leads to reduced feed plus steam flow through the reforming section and the downstream cooling and hydrogen purification sections. Low steam/carbon ratio in the reforming section and shift section enables also higher syngas throughput compared to high steam/carbon ratio. Reduced mass flow through these sections means smaller equipment and piping sizes. The reduced mass flow also results in reduced production of low temperature calories, which can often not be utilised. This means that there is a potential for both lower CapEx (Capital Expenditure) and OpEx (Operating Expenses).

As the requirements to the steam/carbon ratio in the high temperature shift step by the present process is significantly reduced compared to known technologies, it is possible by the present invention to reduce steam/carbon ratio through the front-end to e.g. 0.6 or as low as possible dependent on the possible shift solutions, as further explained below. An advantage of a low steam/carbon ratio to the ATR and in the overall process is that smaller equipment is required in the front-end due to the lower total mass flow through the plant.

It would be understood that the term “front-end” means the reforming section. It would also be understood that the reforming section is the section of the plant comprising units up to and including the reforming unit e.g. the ATR, or a pre-reformer unit and the ATR, or hydrogenator and sulfur absorber and a pre-reformer unit and ATR.

The plant preferably may also comprise an air separation unit (ASU) which is arranged for receiving an air stream and produce an oxygen stream which is then fed through a conduit to the ATR.

The plant preferably comprises also conduits for the addition of steam to the hydrocarbon feed, to the oxygen comprising stream and to the ATR, and optionally also to the inlet of the reforming section e.g. to the main hydrocarbon feed, and also to the inlet of the shift section in particular to the HTS unit, and/or to additional shift units downstream the HTS unit, as it will be described farther below.

According to the present invention, the plant further comprises at least one fired heater arranged to pre-heat said hydrocarbon feed (1, 2) prior to it being fed to the reforming unit (110) e.g. ATR, wherein said plant (100) is arranged to feed at least a part of the CO₂-rich off-gas stream (9) from said hydrogen purification unit (125), or at least part of said CO₂-depleted off-gas stream (17, 17′, 17′') as fuel for said fired heater.

This enables low carbon emission from the flue gas generating from the burning in the fired heaters. A separate fuel gas and/or a hydrogen fuel gas, together with combustion air are suitably used in the fired heater. The consumption of fuel gas such as natural gas, typically used for the burning, is significantly reduced or eliminated. The fired heater, apart from preheating the hydrocarbon feed gas to the prereformer and e.g. ATR, may also be used for example for superheating steam.

Suitably, said CO₂-depleted off-gas stream (17, 17′') is mixed with hydrocarbon feed (2) before being fed to the feed side of the steam reforming unit (110), e.g. ATR; or said CO₂-depleted off-gas stream (17, 17′) is mixed with hydrocarbon feed (1) before being fed to the feed side of the prereformer unit (140).

It would thus be understood that the CO₂-depleted off-gas can be led directly to e.g. the ATR, and/or being mixed with hydrocarbon feed before entering the ATR. Suitably also, the CO₂-depleted off-gas stream is mixed with hydrocarbon feed before being fed to the feed side of the prereformer unit.

In another embodiment, the hydrogen purification unit is selected from a pressure swing adsorption (PSA) unit, a hydrogen membrane, or a cryogenic separation unit.

In another embodiment, the plant is absent of a second (additional) hydrogen purification unit, such as a second PSA unit, downstream said CO₂-removal section. Hence, further enrichment of the CO₂-depleted off-gas into a separate H₂-product is not required, as the CO₂-depleted off-gas may have already the required specifications to be recycled to at least the feed side of the reforming unit. Hence, the CO₂-depleted off-gas is directly recycled to at least the feed side of the reforming unit. In other words, according to this embodiment, the plant is arranged to directly recycle said CO₂-depleted off-gas stream or a portion thereof to at least the feed side of the reforming unit, i.e. a conduit is provided for directly recycling said CO₂-depleted off-gas stream or a portion thereof to at least the feed side of the reforming unit (110).

In another embodiment, the shift section comprises one or more additional high temperature shift units in series.

In another embodiment, said shift section further comprises one or more additional shift units downstream the high temperature shift unit. In a particular embodiment, the one or more additional shift units are one or more medium temperature shift units and/or one or more low temperature shift units.

The provision of additional shifts units or shifts steps adds flexibility to the plant and/or process when operation at low steam/carbon ratios. The low steam/carbon ratio may result in a lower than optimal shift conversion which means that in some embodiments it may be advantageous to provide one or more additional shift steps. The one or more additional shift steps may include a medium temperature (MT) shift and/or a low temperature (LT) shift and/or a high temperature shift. Generally speaking, the more converted CO in the shift steps the more gained H₂ and the smaller front end required.

This is also seen from the exothermic shift reaction: CO+H₂O⇄CO₂+H₂+heat

As recited above, steam may optionally be added before and after the high temperature shift step such as before one or more following MT or LT shift and/or HT shift steps in order to maximize performance of said following HT, MT and/or LT shift steps.

Having two or more high temperature shift steps in series (such as a high temperature shift step comprising two or more shift reactors in series e.g. with the possibility for cooling and/or steam addition in between) may be advantageous as it may provide increased shift conversion at high temperature which gives a possible reduction in required shift catalyst volume and therefore a possible reduction in CapEx. Furthermore, high temperature reduces the formation of methanol, a typical shift step byproduct.

Preferably the MT and LT shift steps may be carried out over promoted copper/zinc/alumina catalysts. For example, the low temperature shift catalyst type may be LK-821-2, which is characterized by high activity, high strength, and high tolerance towards sulphur poisoning. A top layer of a special catalyst may be installed to catch possible chlorine in the gas and to prevent liquid droplets from reaching the shift catalyst.

The MT shift step may be carried out at temperatures at 190-360° C.

The LT shift step may be carried out at temperatures at T_{dew}+15-290° C., such as, 200-280° C. For example, the low temperature shift inlet temperature is from T_{dew}+15-250° C., such as 190-210° C.

Reducing the steam/carbon ratio leads to reduced dew point of the process gas, which means that the inlet temperature to the MT and/or LT shift steps can be lowered. A lower inlet temperature can mean lower CO slippage outlet the shift reactors, which is also advantageous for the plant and/or process.

In a second aspect of the invention, there is also provided a process for producing a hydrogen product (8) from a hydrocarbon feed (1, 2), said process comprising the steps of:
providing a plant (100) according to any one of the preceding embodiments of the first aspect of the invention;
supplying a hydrocarbon feed (2) to the reforming unit, e.g. ATR (110), and converting it to a stream of syngas (3);
supplying a stream of syngas (3) from the reforming unit (110) to the shift section, and shifting it in a shift step (115), suitably a high or medium temperature shift step (115), thereby providing a shifted syngas stream (5);
supplying the shifted gas stream (5) from the shift section to a hydrogen purification unit (125), and separating it into a high-purity H₂ stream as said hydrogen product (8) and a CO₂-rich off-gas stream (9); and

the process further comprising:
optionally providing a step for compressing said CO₂-rich off-gas stream (9) i.e. a CO₂-rich off-gas compression step; and a CO₂-removal step in CO₂-removal section (180), thereby providing a step for removing CO₂ from the thus optionally compressed CO₂-rich off-gas stream (9) into a CO₂-rich off-gas stream as CO₂-product stream (11), and a CO₂-depleted off-gas stream (17, 17′, 17″), said optional step for compressing said CO₂-rich off-gas stream (9) being conducted prior to said CO₂ removal section (180), and
feeding said CO₂-depleted off-gas stream or a portion thereof (17, 17′, 17″), optionally via a further compressing step, to: the feed side of the steam reforming unit (110), and/or feed side of the shift section, and/or feed side of the hydrogen purification unit (125), and/or the feed side of optional prereformer unit (140) arranged upstream said reforming unit (110), and/or as fuel for at least one fired heater arranged to pre-heat said hydrocarbon feed (1, 2) prior to it being fed to the reforming unit (110).

As recited above in connection with the first aspect of the invention, the present plant and/or process may operate at steam/carbon rations down to 0.3. Low steam/carbon ratio in the reforming section and the shift section (i.e. optionally including any steam added to the shift section) enables higher syngas throughput compared to high steam/carbon ratio.

In another embodiment according to the second aspect of the invention, the temperature in the high temperature shift step is in the range 300-600° C., such as 360-470° C., or such as 345-550° C. This means that according to the present process it is possible to run a high temperature shift reaction on a feed with much lower steam/carbon ratio than possible by known processes. For example, the high temperature shift inlet temperature may be 300-400° C., such as 350-380° C.

When for instance operating with an ATR, the carbon feed for the ATR is mixed with oxygen and additional steam in the ATR, and a combination of at least two types of reactions take place. These two reactions are combustion and steam reforming.

Combustion zone:

2H₂+O₂⇄2H₂O+heat (3)

CH₄+3/2 O₂⇄CO+2H₂O+heat (4)

Thermal and catalytic zone:

CH₄+H₂O+heat⇄CO+3H₂ (5)

CO+H₂O⇄CO₂+H₂+heat (6)

The combustion of methane to carbon monoxide and water (reaction (4)) is a highly exothermic process. Excess methane may be present at the combustion zone exit after all oxygen has been converted.

The thermal zone is part of the combustion chamber where further conversion of the hydrocarbons proceeds by homogenous gas phase reactions, mostly reactions (5) and (6). The endothermic steam reforming of methane (5) consumes a large part of the heat developed in the combustion zone.

Following the combustion chamber there may be a fixed catalyst bed, the catalytic zone, in which the final hydrocarbon conversion takes place through heterogeneous catalytic reactions. At the exit of the catalytic zone, the synthesis gas preferably is close to equilibrium with respect to reactions (5) and (6).

By present invention it is possible to run the plant and/or process with no additional steam addition between the reforming step(s) and the high temperature shift step.

Suitably, the space velocity in the ATR is low, such as less than 20000 Nm³ C/m³/h, preferably less than 12000 Nm³ C/m³/h and most preferably less 7000 Nm³ C/m³/h. The space velocity is defined as the volumetric carbon flow per catalyst volume and is thus independent of the conversion in the catalyst zone.

Any of the embodiments of the first aspect (plant) of the invention may be used in connection with any of the embodiments of the second aspect (process) of the invention, or vice versa. Any of the associated benefits of embodiments according to the first aspect of the invention may be used in connection with embodiments according to the second aspect of the invention.

The benefits of the present application include:
reduction of hydrocarbon feed, e.g. natural gas, consumption for the same required hydrogen production while increasing the CO₂ capture and hence reducing the CO₂ emission;
as a part of the CO₂-depleted off-gas is also used as fuel to a fired heater, there is low carbon emission from the flue gas generated in the fired heater;
the power consumption in CO₂-rich off-gas recycle compressor arranged for compressing said CO₂-rich off-gas stream, is reduced by adding the CO₂-depleted off-gas back to the reforming unit.

### BRIEF DESCRIPTION OF THE FIGURE

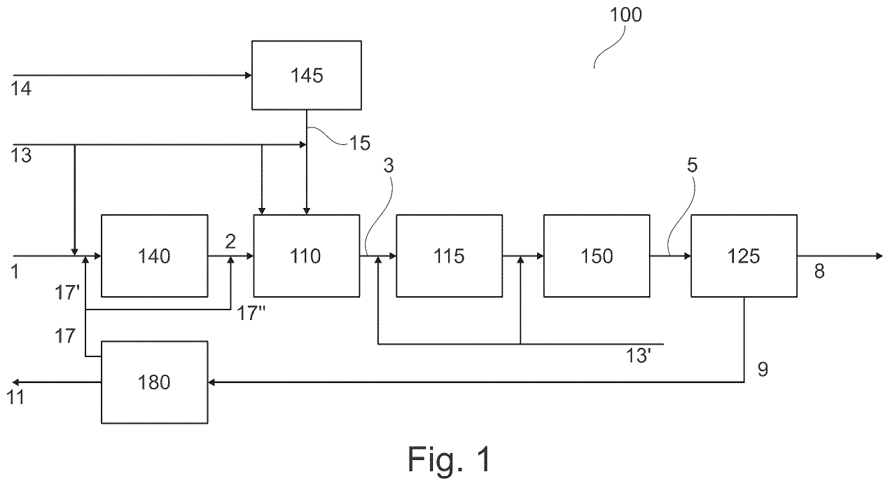

The sole figure (FIG. 1) illustrates a layout of an ATR-based hydrogen process and plant in accordance with an embodiment of the invention.

### DETAILED DESCRIPTION

FIG. 1 shows a plant 100 in which a hydrocarbon feed 1, i.e. main hydrocarbon feed 1, such as natural gas, is passed to a reforming section comprising a pre-reforming unit 140 and a reforming unit here illustrated as an autothermal reformer 110. The reforming section may also include a hydrogenator and sulfur absorber unit (not shown) upstream the pre-reforming unit 140. The hydrocarbon steam 1 is mixed with steam 13. The resulting hydrocarbon feed 2 is fed to ATR 110, as so is oxygen 15 and steam 13. The oxygen stream 15 is produced by means of an air separation unit (ASU) 145, to which air 14 is fed. In the ATR 110, the hydrocarbon feed 2 is converted to a stream of syngas 3, which is then passed to a shift section 115, 150.

The shift section comprises for instance a high temperature shift (HTS) unit 115 where additional or extra steam 13′ also may be added upstream. Additional shift units, such as a low temperature shift (LTS) unit 150 may also be included in the shift section. It would be understood that the shift section may include any of HTS, MTS and LTS, or combinations thereof. Additional or extra steam 13′ may also be added downstream the HTS unit 115 but upstream the low temperature shift unit 150. From the shift section, a shifted gas stream 5 is then fed, e.g. directly fed, to a hydrogen purification unit 125, e.g. a PSA-unit, from which a high-purity H₂ stream as hydrogen product 8 is produced, as well as a CO₂-rich off-gas stream 9. This CO₂-rich off-gas recycle stream 9 is conducted via a recycle compressor (not shown), to CO₂-removal section 180, from which CO₂-product stream 11 is generated, as well as a CO₂-depleted off-gas stream 17, 17′, 17″. The plant 100 is arranged for recycling, e.g. directly recycling, the CO₂-depleted off-gas stream or a portion thereof 17, 17′, 17″ to the feed side of the prereformer 140, or to the feed side of the reforming unit, here ATR 110, or to the shift section (not shown). The plant 100 further comprises at least one fired heater (not shown) arranged to pre-heat the hydrocarbon feed 1, 2 prior to it being fed to pre-reforming unit 140 or reforming unit 110, and the plant (100) is arranged to feed, e.g. directly feed, at least a part of the CO₂-rich off-gas stream 9 from said hydrogen purification unit 125, or at least part of said CO₂-depleted off-gas stream 17, 17′, 17″ as fuel for the fired heater.

### EXAMPLE

In a process and plant 100 for removing carbon dioxide from a CO₂ rich syngas 5, CO₂-depleted off-gas 17 is generated after removal of CO₂ as CO₂-product stream 11 in CO₂-removal section 180. The composition of the CO₂-depleted off-gas may be as follows: hydrogen 85 mol %, methane 7 mol %, CO 7 mol %, nitrogen+argon 1 mol %. The CO₂-depleted off-gas 17 is recycled back directly to the reforming unit 110, here specifically an exemplified as an ATR, and further with an upstream prereformer unit 140. This results in more reforming of methane into hydrogen as well as shifting of CO into CO₂ in shifting units 115, 150. The benefits of this include reduction of hydrocarbon feed (e.g. natural gas) consumption for the same required hydrogen production while increasing the CO₂ capture and hence reducing the CO₂ emission. A part of the CO₂-depleted off-gas is also used as fuel to a fired heater. This results in low carbon emission from the flue gas generated in the fired heater.

10 Furthermore, the power consumption in a compressor i.e. CO₂-rich off-gas recycle compressor (not shown in the appended figure) arranged for compressing said CO₂-rich off-gas stream 9, is reduced by adding the CO₂-depleted off-gas back to reforming unit 110, here the ATR.

1. A plant for producing a hydrogen product from a hydrocarbon feed, said plant comprising:
a reforming unit, said reforming unit being arranged to receive a hydrocarbon feed and convert it to a stream of syngas;
a shift section arranged to receive a stream of syngas from the steam reforming unit and shift it, thereby providing a shifted syngas stream;
a hydrogen purification unit, arranged to receive said shifted syngas stream and separate it into a high-purity H₂ stream as said hydrogen product, and CO₂-rich off-gas stream;
a CO₂-removal section for removal of CO₂ from the CO₂-rich off-gas stream into a CO₂-product stream and a CO₂-depleted off-gas stream, and wherein said plant is arranged for recycling said CO₂-depleted off-gas stream or a portion thereof, at least to the feed side of the reforming unit;
wherein the plant further comprises at least one fired heater arranged to pre-heat said hydrocarbon feed prior to it being fed to the reforming unit, and wherein said plant is arranged to feed at least a part of the CO₂-rich off-gas stream from said hydrogen purification unit, or at least part of said CO₂-depleted off-gas stream as fuel for said fired heater.

2. The plant according to claim 1, wherein:
said shift section comprises a high or medium temperature shift unit.

3. The plant according to claim 1, wherein the reforming unit is: an autothermal reformer; a partial oxidation reformer; a convection heated reformer; a steam methane reformer; or combinations thereof.

4. The plant according to claim 1, wherein said plant is arranged to directly provide said shifted syngas stream to said hydrogen purification unit.

5. The plant according to claim 1, wherein the CO₂ removal section is selected from: an amine wash unit, or a CO₂ membrane, CO₂-PSA, or a cryogenic separation unit.

6. The plant according to claim 1, wherein
said plant-{100} further comprises one prereformer 140 arranged upstream the reforming, said prereformer unit being arranged to pre-reform said hydrocarbon feed prior to it being fed to the reforming unit and wherein said plant is arranged to feed at least a part of the CO₂-depleted off-gas stream to the feed side of the prereformer unit; and/or
said plant is arranged to feed at least a part of the CO₂-depleted off-gas stream to the feed side of the shift section; and/or
said plant is arranged to feed at least a part of said CO₂-depleted off-gas stream to the feed side of the hydrogen purification unit.

7. The plant according to claim 1, further comprising:
a compressor i.e. CO₂-rich off-gas recycle compressor arranged for compressing said CO₂-rich off-gas stream, said compressor being adapted upstream said CO₂ removal section, and optionally a compressor being adapted downstream said CO₂ removal section, for recycling said CO₂-depleted-gas stream or a portion thereof, to the feed side of the reforming unit, and/or to the feed side of the shift section, and/or to the feed side of the prereformer unit, and/or to the feed side of the hydrogen purification unit.

8. The plant according to any claim 6, wherein the reforming unit is an ATR with said one prereformer unit arranged upstream.

9. The plant according to claim 1, wherein the hydrogen purification unit is selected from a pressure swing adsorption unit, a hydrogen membrane or a cryogenic separation unit.

10. The plant according to claim 1, wherein the plant is arranged to directly recycle said CO₂-depleted off-gas stream or a portion thereof to at least the feed side of the reforming unit.

11. A process for producing a hydrogen product from a hydrocarbon feed, said process comprising the steps of:
providing a plant according to any one of the preceding claims; supplying a hydrocarbon feed to the reforming unit and converting it to a stream of syngas;
supplying a stream of syngas from the reforming unit to the shift section, and shifting it in a shift step, thereby providing a shifted syngas stream;
supplying the shifted gas stream from the shift section to a hydrogen purification unit, and separating it into a high-purity H₂ stream as said hydrogen product and a CO₂-rich off-gas stream; and
the process further comprising:
optionally providing a step for compressing said CO₂-rich off-gas stream i.e. a CO₂-rich off-gas compression step; and a CO₂-removal step in CO₂-removal section, thereby providing a step for removing CO₂ from the thus optionally compressed CO₂-rich off-gas stream into a CO₂-rich off-gas stream as CO₂-product stream and a CO₂-depleted off-gas stream, said optional step for compressing said CO₂-rich off-gas stream being conducted prior to said CO₂ removal section, and
feeding said CO₂-depleted off-gas stream or a portion thereof, optionally via a further compressing step, to the feed side of the reforming unit, and/or feed side of the shift section, and/or feed side of the hydrogen purification unit, and/or the feed side of optional prereformer unit arranged upstream said reforming unit, and/or as fuel for at least one fired heater arranged to pre-heat said hydrocarbon feed prior to it being fed to the reforming unit.
